(19) United States
(12) Patent Application Publication
(10) Pub. No.: US 2024/0358030 A1
(43) Pub. Date: Oct. 31, 2024

(54) SMOKED PRETZEL

(71) Applicant: Heartland Creations, LLC, Fargo, ND (US)

(72) Inventor: Barbra Lee Barnes, Courtenay, ND (US)

(21) Appl. No.: 18/649,677

(22) Filed: Apr. 29, 2024

Related U.S. Application Data
(60) Provisional application No. 63/498,561, filed on Apr. 27, 2023.

(51) Int. Cl. A21D 8/02; A21D 13/40

(52) U.S. Cl. CPC A21D 8/025; A21D 13/40

(57) ABSTRACT

A method to make smoked pretzels includes mixing ingredients to form a pretzel mix: inserting the pretzel mix into a smoker; smoking the pretzel mix for a multiple of times each at a different temperature; and removing the smoked pretzel mix.

### CROSS REFERENCE TO RELATED APPLICATION[S]

The present disclosure claims priority to United States Provisional Patent Disclosure Ser. No. 63/498,561 filed Apr. 27, 2023.

### BACKGROUND

The present disclosure relates to baked goods, and more specifically to a smoked pretzel.

A pretzel is a delicious type of baked bread made from dough. Pretzels may come in a variety of shapes such as sticks, rods, knots, and the classic pretzel knot shape. Pretzels are often seasoned with salt.

### SUMMARY

A method to make smoked pretzels according to one disclosed non-limiting embodiment of the present disclosure includes, mixing ingredients to form a pretzel mix; inserting the pretzel mix into a smoker; smoking the pretzel mix for a multiple of times each at a different temperature; and removing the smoked pretzel mix.

A further embodiment of any of the foregoing embodiments of the present disclosure includes that the multiple of times comprises four times.

A further embodiment of any of the foregoing embodiments of the present disclosure includes that each temperature is greater than a subsequent temperature.

A further embodiment of any of the foregoing embodiments of the present disclosure includes that a first temperature is between 130 F-170 F degrees, a second temperature is between 150 F-200 F degrees, a third temperature is between 175 F-225 F degrees, and a fourth temperature is between 200 F-250 F degrees.

A further embodiment of any of the foregoing embodiments of the present disclosure includes that a first temperature is between 140 F-160 F degrees, a second temperature is between 160 F-190 F degrees, a third temperature is between 190 F-210 F degrees, and a fourth temperature is between 215 F-235 F degrees.

A further embodiment of any of the foregoing embodiments of the present disclosure includes that a first temperature is 150 F degrees, a second temperature is 175 F degrees, a third temperature is 200 F degrees, and a fourth temperature is 225 F degrees.

A further embodiment of any of the foregoing embodiments of the present disclosure includes that mixing ingredients comprises mixing sixty (60) ounces of pretzels, sixteen (16) fluid ounces of butter flavored oil, one-third (⅓) cup of spicy ranch powder, three (3) tablespoons of creole seasoning, and one (1) tablespoon of ground cayenne pepper.

A further embodiment of any of the foregoing embodiments of the present disclosure includes that allowing the pretzel mix to rest for 10 minutes prior to the inserting.

A method to make smoked pretzels according to one disclosed non-limiting embodiment of the present disclosure includes mixing ingredients to form a pretzel mix; heating a smoker to a first temperature; inserting the pretzel mix into the smoker; smoking the pretzel mix for a first time; heating to a second temperature; smoking the pretzel mix for a second time; heating to a third temperature; smoking the pretzel mix for a third time; heating to a fourth temperature; smoking the pretzel mix for a fourth time; and removing the smoked pretzel mix.

A further embodiment of any of the foregoing embodiments of the present disclosure includes that mixing ingredients comprises mixing sixty (60) ounces of pretzels, sixteen (16) fluid ounces of butter flavored oil, one-third (⅓) cup of spicy ranch powder, three (3) tablespoons of creole seasoning, and one (1) tablespoon of ground cayenne pepper.

A further embodiment of any of the foregoing embodiments of the present disclosure includes that a first temperature is between 130 F-170 F degrees, a second temperature is between 150 F-200 F degrees, a third temperature is between 175 F-225 F degrees, and a fourth temperature is between 200 F-250 F degrees.

A further embodiment of any of the foregoing embodiments of the present disclosure includes that a first temperature is between 140 F-160 F degrees, a second temperature is between 160 F-190 F degrees, a third temperature is between 190 F-210 F degrees, and a fourth temperature is between 215 F-235 F degrees.

A further embodiment of any of the foregoing embodiments of the present disclosure includes that a first temperature is 150 F degrees, a second temperature is 175 F degrees, a third temperature is 200 F degrees, and a fourth temperature is 225 F degrees.

A further embodiment of any of the foregoing embodiments of the present disclosure includes that allowing the pretzel mix to rest for 10 minutes prior to the inserting.

A further embodiment of any of the foregoing embodiments of the present disclosure includes a smoked pretzel from the smoked pretzel mix subjected to a of a 3-point bend test defines a mean value between 11.4-13.6 with a 95% confidence interval.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a simplified block diagram showing the relation between the steps of a method for baking pretzels.

### DETAILED DESCRIPTION

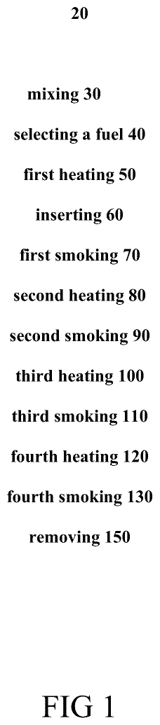

FIG. 1 is a simplified block diagram showing the relation between the steps of a method 20 for baking pretzels. The method may be referenced herein as the “smoking” process for smoking pretzels. The final product derived from the smoking process may be referenced herein as the “smoked pretzels.”

The method 20 is comprised of mixing 30 ingredients, selecting 40 a fuel, a first heating 50 to a first temperature, inserting 60 a pretzel mix, a first smoking 70 for a first time, a second heating 80 to a second temperature, a second smoking 90 for a second time, a third heating 100 to a third temperature, a third smoking 110 for a third time, a fourth heating 120 to a fourth temperature, a fourth smoking 130 for a fourth time and removing 150 the pretzel mix.

The method, as disclosed herein, utilizes multiple different temperatures in a specific sequence to provide a sequence of smoking. The smoking process may be completed using a certain desired fuel selection. Smoking may include the process of flavoring, browning, cooking, or preserving food by exposing it to smoke from burning or smoldering a fuel. This burnt or smoldered fuel may be a type of wood. Selecting the type of fuel may have an impact on the outcome of the food being smoked. The length and temperature of the smoking process provides an outcome to the pretzel mix. A unique pretzel product may be derived by smoking using these temperatures with the specific fuel.

The mixing 30 may include the combination of ingredients with pre-baked pretzels. That is, the combination of ingredients are mixed to essentially provide a specific coating that is applied to the pre-made pretzels which are then smoked.

In accordance with a first embodiment, the ingredients to be mixed for one batch of smoked pretzels to undergo the smoking process may include sixty (60) ounces of pre-made pretzels, sixteen (16) fluid ounces of butter-flavored oil, one-third (⅓) cup of spicy ranch powder, three (3) tablespoons of creole seasoning, and one (1) tablespoon of ground cayenne pepper. Although a particular batch recipe is disclosed, any proportion of one batch may be used to form the “pretzel mix.” For example, the ingredients may be doubled, tripled, halved, multiplied by fifty, or any other proportion. The final product is ingredient specific.

In this embodiment, the ingredients are mixed then allowed to rest for a minimum of 10 minutes so that the ingredients soak into the pre-made pretzels before being placed in the smoker. Upon completing the mixing 30, the product of the mixed ingredients and the pre-made pretzels may be referenced herein as the “pretzel mix.”

The pre-made pretzels may be any suitable pretzel type or brand. The pretzels may be, for example, a pretzel sold under the trademark UTZ Quality Foods designated as a Mini-Twist.

The butter-flavored oil may be from any suitable butter-flavored oil type or brand. The butter-flavored oil may be, for example, a butter-flavored oil sold under the trademark Orville Redenbacher Popping and Topping.

The ranch powder may be from any suitable ranch powder type or brand. The ranch powder may be, for example, a ranch powder sold under the trademark Hidden Valley ranch powder.

The creole seasoning may be from any suitable Creole or Cajun type seasoning or brand. The creole seasoning may be, for example, a creole seasoning sold under the trademark Tony Chachere's Original Creole.

Selecting 40 of the fuel includes selecting a fuel and configuring a smoker to utilize the fuel. A smoker may be an apparatus for cooking at temperatures in a controlled, smoky environment. A smoker may be constructed in various ways to allow for fuel to be utilized. Fuel may be pulled or pushed into the smoker. In one example, the smoker may have an auger that causes the fuel to be moved into a cooking chamber, such as wood pellets. Selecting 40 includes configuring the smoker to utilize the selected fuel. For example, the fuel may be placed in an intake of a smoker to be moved into the cooking chamber. The smoker may be configured to cause the fuel to enter the cooking chamber at a desired rate. The desired rate may be consistent with the design of the smoker, the desired temperature, the fuel, and other factors.

The fuel may be selected from any suitable fuel for a smoker and may be of any type or brand. The fuel may be, for example, a wood fuel material. A wood fuel may be wood pellets of a certain type of wood. The fuel may be a wood pellet sold under the trademark Pit Boss Competition Blend.

The first heating 50 to the first temperature causes the smoker to maintain the first temperature within the cooking chamber. The first temperate may be within a desired range. In one embodiment, the first temperature may be between 130 F-170 F degrees, and more specifically may be between 140 F-160 F degrees, and still more specifically may be 150 F degrees. The heating may be complete upon configuring, manually or automatically, the heat setting of the cooking chamber to the desired temperature.

Next, after the first heating 50 has been achieved, the “pretzel mix” is inserted at the step of inserting 60. This includes the step of moving the pretzel mix into the cooking chamber. Inserting 60 need not require a specific quantity of pretzel mix. For example, a half batch, a full batch, or multiples of a batch may be inserted. Equipment may also be used in which the pretzel mix is moved in a conveyer like arrangement through a multiple of smokers each at the desired temperate. The “pretzel mix” may be maintained within the same smoker from beginning to the end.

After the inserting 60, the first smoking 70 occurs for the first time. The first smoking 70 may be defined for the length of time the pretzel mix is smoked at the first temperature. The first time may be within a desired range. In one embodiment, the first time may be between 45 minutes-75 minutes, and more specifically may be between 50 minutes-70 minutes, and still more specifically may be 60 minutes.

Next, the second heating 80 to the second temperature causes the smoker to maintain the second temperature within the cooking chamber for the second smoking 90. The second temperate may be within a desired range. In one embodiment, the second temperature may be between 150 F-200 F degrees, and more specifically may be between 160 F-190 F degrees, and still more specifically may be 175 F degrees.

The second smoking 90 may be defined for the length of time the pretzel mix is smoked at the second temperature. The second time may be within a desired range. In one embodiment, the second time may be between 45 minutes-75 minutes, and more specifically may be between 50 minutes-70 minutes, and still more specifically may be 60 minutes.

Next, the third heating 100 to the third temperature causes the smoker to maintain the third temperature within the cooking chamber for the third smoking 110. The third temperate may be within a desired range. In one embodiment, the third temperature may be between 175 F-225 F degrees, and more specifically may be between 190 F-210 F degrees, and still more specifically may be 200 F degrees.

The third smoking 110 may be defined for the length of time the pretzel mix is smoked at the third temperature. The third time may be within a desired range. In one embodiment, the third time may be between 45 minutes-75 minutes, and more specifically may be between 50 minutes-70 minutes, and still more specifically may be 60 minutes.

Next, the fourth heating 120 to the fourth temperature causes the smoker to maintain the fourth temperature within the cooking chamber for the fourth smoking 130. The fourth temperate may be within a desired range. In one embodiment, the fourth temperature may be between 200 F-250 F degrees, and more specifically may be between 215 F-235 F degrees, and still more specifically may be 225 F degrees.

The fourth smoking 130 may be defined for the length of time the pretzel mix is smoked at the fourth temperature. The fourth time may be within a desired range. In one embodiment, the fourth time may be between 45 minutes-75 minutes, and more specifically may be between 50 minutes-70 minutes, and still more specifically may be 60 minutes.

Finally, removing 150 the pretzel mix may be the step when the smoking process is finished, and the smoked pretzel “pretzel mix” are complete. Removing 150 may be done by an individual, by automated means, or by other means. For example, a person may remove the pretzel mix from the cooking chamber upon completion of the smoking.

The method as disclosed herein utilizes different temperatures during the smoking process. Further, the smoking process may be completed using a certain desired fuel selection. A unique pretzel product may be derived by using the smoking at the multiple disclosed temperatures in combination with the specific fuel. The smoking method disclosed herein provides a specific texture and thus a desirous “crunch.”

A 3-point bend analysis was employed to analyze the samples. A TA-HD plus instrument (Texture Technologies Corp., Hamilton, MA) was equipped with a 5 kg load cell. The 3-point bend rig (TA-92N Texture Technologies Corp., Hamilton, MA) was used with a rounded test blade and the upright supports were set to a 25 mm gap. Each individual pretzel was placed centered on the uprights. The blade travelled 10 mm at 2 mm/sec to fracture the samples symmetrically through the knot in the middle. 25 replicates were tested for each of 3 provided sample bags, for a total of 75 replicates.

The 3-point bend test results correlate with the first bite or snap of the snack. The harder the snack, the higher the force that is measured. Lower results show a more tender or softer snack. The results can be viewed as separate bag results and aggregated results. Separate bag results show how the bags differ from each other, while the aggregated results show the average value for all the samples, along with overall variability across the bags and ages. In one embodiment, a smoked pretzel from the smoked pretzel mix subjected to a 3-point bend test defines a mean value between 11.4-13.6 N with a 95% confidence interval.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason, the appended claims should be studied to determine true scope and content.

1. A method to make smoked pretzels comprising:
mixing ingredients to form a pretzel mix;
inserting the pretzel mix into a smoker;
smoking the pretzel mix for a multiple of times each at a different temperature; and
removing the smoked pretzel mix.

2. The method as recited in claim 1, wherein the multiple of times comprises four times.

3. The method as recited in claim 2, wherein each temperature is greater than a subsequent temperature.

4. The method as recited in claim 2, wherein a first temperature is between 130 F-170 F degrees, a second temperature is between 150 F-200 F degrees, a third temperature is between 175 F-225 F degrees, and a fourth temperature is between 200 F-250 F degrees.

5. The method as recited in claim 2, wherein a first temperature is between 140 F-160 F degrees, a second temperature is between 160 F-190 F degrees, a third temperature is between 190 F-210 F degrees, and a fourth temperature is between 215 F-235 F degrees.

6. The method as recited in claim 2, wherein a first temperature is 150 F degrees, a second temperature is 175 F degrees, a third temperature is 200 F degrees, and a fourth temperature is 225 F degrees.

7. The method as recited in claim 1, wherein mixing ingredients comprises mixing sixty (60) ounces of pretzels, sixteen (16) fluid ounces of butter flavored oil, one-third (⅓) cup of spicy ranch powder, three (3) tablespoons of creole seasoning, and one (1) tablespoon of ground cayenne pepper.

8. The method as recited in claim 7, further comprising allowing the pretzel mix to rest for 10 minutes prior to the inserting.

9. A method to make smoked pretzels comprising:
mixing ingredients to form a pretzel mix;
heating a smoker to a first temperature;
inserting the pretzel mix into the smoker;
smoking the pretzel mix for a first time;
heating to a second temperature;
smoking the pretzel mix for a second time;
heating to a third temperature;
smoking the pretzel mix for a third time;
heating to a fourth temperature;
smoking the pretzel mix for a fourth time; and
removing the smoked pretzel mix.

10. The method as recited in claim 9, wherein mixing ingredients comprises mixing sixty (60) ounces of pretzels, sixteen (16) fluid ounces of butter flavored oil, one-third (⅓) cup of spicy ranch powder, three (3) tablespoons of creole seasoning, and one (1) tablespoon of ground cayenne pepper.

11. The method as recited in claim 10, wherein a first temperature is between 130 F-170 F degrees, a second temperature is between 150 F-200 F degrees, a third temperature is between 175 F-225 F degrees, and a fourth temperature is between 200 F-250 F degrees.

12. The method as recited in claim 10, wherein a first temperature is between 140 F-160 F degrees, a second temperature is between 160 F-190 F degrees, a third temperature is between 190 F-210 F degrees, and a fourth temperature is between 215 F-235 F degrees.

13. The method as recited in claim 10, wherein a first temperature is 150 F degrees, a second temperature is 175 F degrees, a third temperature is 200 F degrees, and a fourth temperature is 225 F degrees.

14. The method as recited in claim 9, further comprising allowing the pretzel mix to rest for 10 minutes prior to the inserting.

15. The method as recited in claim 9, wherein a smoked pretzel from the smoked pretzel mix subjected to a 3-point bend test defines a mean value between 11.4-13.6 N with a 95% confidence interval.

16. A smoked pretzel comprising:
a pretzel smoked a multiple of times with at least, a butter flavored oil, a spicy ranch powder, a creole seasoning, and a ground cayenne pepper such that the smoked pretzel subjected to a 3-point bend test defines a mean value between 11.4-13.6 N with a 95% confidence interval.
